(19) United States
(12) Patent Application Publication
(10) Pub. No.: US 2023/0023375 A1
(43) Pub. Date: Jan. 26, 2023

(54) SPRING CONNECTOR

(71) Applicant: PEGATRON CORPORATION, Taipei (TW)

(72) Inventors: Sheng-Yang Hung, Taipei (TW); Chin-Chun Chiang, Taipei (TW)

(21) Appl. No.: 17/703,553

(22) Filed: Mar. 24, 2022

(30) Foreign Application Priority Data
Jul. 26, 2021 (TW) 110127412

(51) Int. Cl. H01R 13/648; H01R 13/24

(52) U.S. Cl. CPC H01R 13/6485; H01R 13/2407

(57) ABSTRACT

Provided is a spring connector, including a base, a plurality of connector female ends and a grounding ring. The base has a surface. The plurality of connector female ends are disposed on the base and exposed on the surface. End portions exposed on the surface are recessed in the surface. The grounding ring is disposed on the base and exposed on the surface, and correspondingly surrounds at least one of the plurality of connector female ends. An end portion of the grounding ring exposed on the surface is flush with the surface or protrudes from the surface.

### CROSS-REFERENCE TO RELATED APPLICATION

This application claims the priority benefit of Taiwanese application serial no. 110127412, filed on Jul. 26, 2021. The entirety of the above-mentioned patent application is hereby incorporated by reference herein and made a part of this specification.

### BACKGROUND

### Technical Field

The present disclosure relates to a spring connector, in particular to a spring connector with a grounding ring.

### Background

In the current design of a spring connector, pins are usually exposed on the surface of the connector or the final product assembled with the connector. Since the pins of the spring connector are exposed on the surface of the connector or final product, a user may easily come into direct contact with the pins of the spring connector when mating the male and female ends of the spring connector. When a human body contacts the pins of the spring connector, it is possible to generate weak electrostatic discharge due to the connection to the ground. For electronic parts such as integrated circuits, even a weak current through the circuit will lead to abnormalities, and this electrostatic discharge may also damage the electronic parts due to static electricity, i.e. electrostatic damage.

### SUMMARY

In view of the above, in an embodiment, the present disclosure provides a spring connector, including a base, a plurality of connector female ends and a grounding ring. The base has a surface. The plurality of connector female ends are disposed on the base and exposed on the surface. End portions exposed on the surface are recessed in the surface. The grounding ring is disposed on the base and exposed on the surface, and correspondingly surrounds at least one of the plurality of connector female ends. An end portion of the grounding ring exposed on the surface is flush with the surface or protrudes from the surface.

Based on the above, when the spring connector of the embodiment of the present disclosure is disposed in an electronic device, since the connector female ends are recessed in the surface of the base, and are not directly flush with the surface of the base or protrudes from the base, when the user operates, even if his hand contacts the base, it will not directly contact the connector female end, which leads to electrostatic damage caused by the contact between the human body and the connector female end. Further, by the grounding ring surrounding the outer circumference of the connector female end, the grounding ring is flush with the surface or protrudes from the surface. If the user contacts the position where the connector female end is disposed on the base, the user will contact the grounding ring first, so that static electricity can be discharged out through the grounding ring, thereby avoiding electrostatic damage.

### BRIEF DESCRIPTION OF THE DRAWINGS

FIG. 1 is a partial schematic view of a spring connector according to a first embodiment of the present disclosure.

FIG. 2 is a partial schematic cross-sectional view of the spring connector according to the first embodiment of the present disclosure.

FIG. 3 is a partial schematic view of the spring connector assembled in a casing according to the first embodiment of the present disclosure.

FIG. 4 is a partial schematic view of a spring connector according to a second embodiment of the present disclosure.

FIG. 5 is a partial schematic cross-sectional view of the spring connector according to the second embodiment of the present disclosure.

FIG. 6 is a partial schematic view of a spring connector according to a third embodiment of the present disclosure.

### DETAILED DESCRIPTION

Various embodiments are provided below for detailed description. However, the embodiments are merely used as examples for illustration, and do not limit the protection scope of the present invention. In addition, some elements are omitted in the drawings in the embodiments to clearly show the technical features of the present disclosure. The same reference numerals are used to indicate the same or similar elements in all of the drawings.

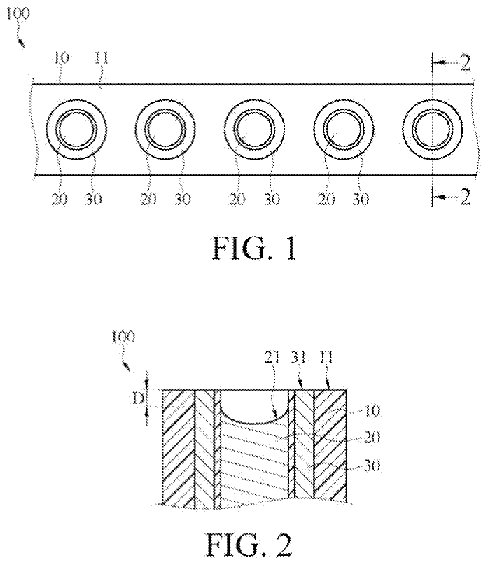

FIG. 1 is a partial schematic view of a spring connector according to a first embodiment of the present disclosure. FIG. 2 is a partial schematic cross-sectional view of the spring connector according to the first embodiment of the present disclosure. FIG. 1 shows the partial schematic view of the spring connector 100 in this embodiment, and FIG. 2 shows the partial schematic cross-sectional view of a single connector female end taken along line 22 in FIG. 1. In this embodiment, the spring connector 100 includes a base 10, a plurality of connector female ends 20 and a grounding ring 30. The base 10 has a surface 11. The plurality of connector female ends 20 are disposed on the base 10 and exposed on the surface 11. End portions 21 exposed on the surface 11 are recessed in the surface 11. Referring to FIG. 2, the end portion 21 of the connector female end 20 is farther into the base 10 than the surface 11 of the base 10, and will not be flush with the surface 11 of the base 10 or protrude from the surface 11 of the base 10. Thus, when the user mates the male and female ends of the connector, even if his hand contacts the base 10 of the spring connector 100, it will not directly contact the end portion 21 of the connector female end 20 disposed in the base 10. Therefore, the first embodiment preliminarily avoids the possible electrostatic damage caused by direct contact between the human body and the connector female end 20.

Still referring to FIG. 1 and FIG. 2, the grounding ring 30 is disposed on the base 10 and exposed on the surface 11, and correspondingly surrounds at least one of the plurality of connector female ends 20. In this embodiment, for example, there are a plurality of the grounding rings 30, and each of the grounding rings 30 correspondingly surrounds one of the connector female ends 20. As can be seen from FIG. 1, in this embodiment, for example, there are five connector female ends 20, and correspondingly, there are five grounding rings 30. Each of the grounding rings 30 surrounds the outer circumference of the connector female end 20 and does not contact the connector female end 20.

In the meanwhile, as can be seen from FIG. 2, an end portion 31 of the grounding ring 30 exposed on the surface 11 is flush with the surface 11. The end portion 31 of the grounding ring 30 is closer to the surface 11 of the base 10 than the end portion 21 of the connector female end 20. Thereby, by the grounding ring 30 surrounding the outer circumference of the connector female end 20, the end portion 31 of the grounding ring 30 is flush with the surface 11. If the user contacts the position where the connector female end 20 is disposed on the surface 11 of the base 10, the user will contact the grounding ring 30 first, so that static electricity can be discharged out through the grounding ring 30, thereby avoiding electrostatic damage.

Besides, in this embodiment, the end portions 31 of the plurality of connector female ends 20 exposed on the surface 11 are recessed in the surface 11 by a distance of about 1-2 mm, such that the hand cannot contact the end portion 31 of the connector female end 20 when contacting the surface 11. Within this distance range, a connector male end can be connected with the recessed connector female end 20 without increasing much length.

In addition, in this embodiment, the base 10 may be made of an insulating material, and the plurality of connector female ends 20 and the plurality of grounding rings 30 are insulated from each other, and are not connected to each other or connected to the same ground terminal. Thus, when the grounding ring 30 is in contact with the hand, the static electricity is discharged out, which avoids the influence on the connector female end 20.

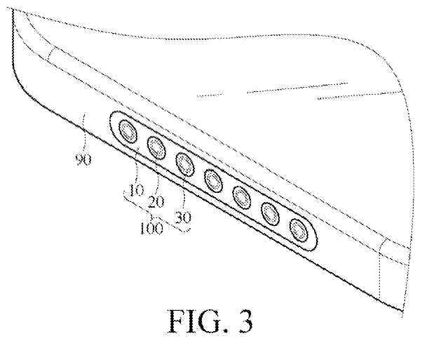

Next, referring to FIG. 1 to FIG. 3, FIG. 3 shows a partial schematic view of the spring connector assembled in a casing according to the first embodiment of the present disclosure. In this embodiment, for example, the spring connector 100 is disposed in the casing 90 of an electronic device. The electronic device is, for example, but not limited to, a mobile device. The electronic device may be a hand-held or non-hand-held electronic device, as long as the spring connector 100 can be disposed therein. In this embodiment, when the spring connector 100 is assembled in the casing 90, the grounding ring 30 and the ground terminal of the casing 90 can be connected to ground, so that the static electricity is led to the entire casing 90, which thus clears off the possible direct electrostatic damage to the inside electronic components.

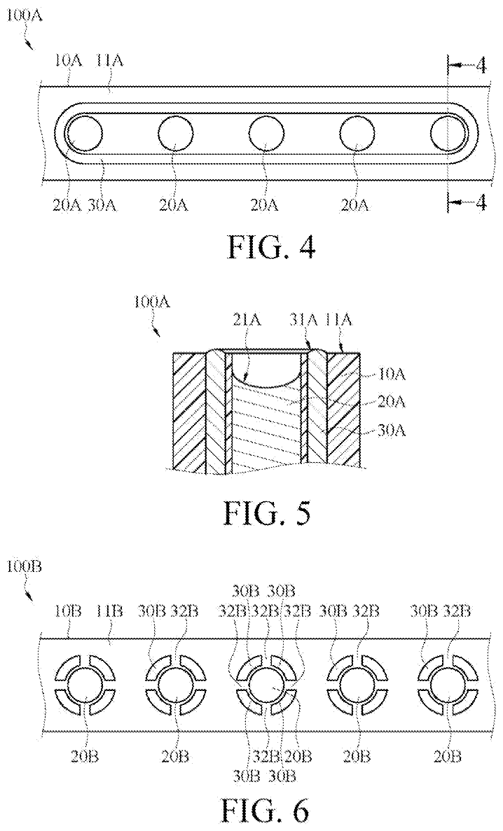

Next, referring to FIG. 4 and FIG. 5, FIG. 4 is a partial schematic view of a spring connector according to a second embodiment of the present disclosure, and FIG. 5 is a partial schematic cross-sectional view of the spring connector according to the second embodiment of the present disclosure. FIG. 4 shows the partial schematic view of the spring connector 100A in this embodiment, and FIG. 5 shows the partial schematic cross-sectional view of a single connector female end taken along line 44 in FIG. 4. In this embodiment, the spring connector 100A includes a base 10A, a plurality of connector female ends 20A and a grounding ring 30A. The base 10A and the plurality of connector female ends 20A of this embodiment are basically the same as those in the first embodiment, and thus, will not be repeated here, referring to FIG. 4, the grounding ring 30A of this embodiment is a single ring, and when viewed from the top of the surface 11A (i.e., the view in FIG. 4), is a closed ring that surrounds all the connector female ends 20A. Since the width portion of the whole spring connector 100A as shown in the up-down direction in the figure is generally smaller than the size of a finger, this arrangement can also make the finger contact the grounding ring 30A first, so that the static electricity is discharged out. In other implementations, there may be a plurality of grounding rings, and the grounding rings each respectively surround a plurality of connector female ends.

Besides, referring to FIG. 5, in this embodiment, an end portion 31A of the grounding ring 30A exposed on the surface 11A may protrude from the surface 11A. The protruding extend of the end portion 31A does not need to be very large, as long as the end portion slightly protruding out of the surface such that the hand can contact the end portion 31A first when contacting the position on the surface 11A of the base 10 corresponding to the connector female end 20A, which makes the possible static electricity discharged out. The end portion 31A slightly protruding from the surface 11A can also ensure the hand to contact the end portion 31A first, which thus prevents the finger pulp from going into the surface 11A and contacting the end portion 21A of the connector female end 20A first.

Next, referring to FIG. 6, FIG. 6 is a partial schematic view of a spring connector according to a third embodiment of the present disclosure. In this embodiment, the spring connector 100B includes a base 10B, a plurality of connector female ends 20B and a grounding ring 30B. The base 10B and the plurality of connector female ends 20B of this embodiment are basically the same as those in the first embodiment, and thus, will not be repeated here. As can be seen from FIG. 6, there are also a plurality of grounding rings 30B, and each of the grounding rings 30B correspondingly surrounds one of the connector female ends 20B. However, the grounding ring 30B is a ring with a plurality of fractures 32B when viewed from the top of a surface 11B (i.e., the view in FIG. 6).

In this embodiment, although four fractures 32B are shown as an example, it is only for illustration, and the number of the fractures 32B may be larger or smaller, depending on the size of the connector female end 20B. The size of the fracture 32B should be smaller than a surface area that the hand may contact when contacting the surface 11B of the base 10B. For example, if a fingertip contacts the surface 11B of the base 10B, the size of the fracture 32B should be smaller than the size of the surface 11B that the fingertip may contact transiently, for example, smaller than 2 mm. This may also make the finger contact the grounding ring 30B first, so that the static electricity is discharged out.

What is claimed is:

1. A spring connector, comprising:
a base, having a surface;
a plurality of connector female ends, disposed on the base and exposed on the surface, end portions exposed on the surface being recessed in the surface; and
a grounding ring, disposed on the base and exposed on the surface, and correspondingly surrounding at least one of the connector female ends, an end portion of the grounding ring exposed on the surface being flush with the surface or protruding from the surface.

2. The spring connector according to claim 1, wherein there are a plurality of the grounding rings, and each of the grounding rings correspondingly surrounds one of the connector female ends.

3. The spring connector according to claim 1, wherein the grounding ring is a closed ring when viewed from the surface.

4. The spring connector according to claim 1, wherein the grounding ring is a ring with a plurality of fractures when viewed from the surface.

5. The spring connector according to claim 1, disposed in a casing, wherein the grounding ring and a ground terminal of the casing are connected to ground.

6. The spring connector according to claim 1, wherein the connector female ends and the grounding ring are insulated from each other.

7. The spring connector according to claim 1, wherein the end portions of the connector female ends exposed on the surface are recessed in the surface by a distance of 1 to 2 mm.
